(19) United States
(12) Patent Application Publication
(10) Pub. No.: US 2006/0108453 A1
(43) Pub. Date: May 25, 2006

(54) System and method for subterranean watering

(76) Inventor: Roger Q. McFarland, (US)

Correspondence Address: Michele Holden;Suite B, 1921 Motor Ave., Kingman, AZ, 86401, US

(21) Appl. No.: 10/996,492

(22) Filed: Nov. 24, 2004

(51) Int. Cl. B05B 15/00; B05B 1/26; F23D 11/36

(52) U.S. Cl. 239/542; 239/543; 239/544; 239/545

(57) ABSTRACT

An subterranean watering system and method for use with convention irrigation systems, including drip irrigation systems, comprising a first hollow tube; a second hollow tube; a cap disposed on a first end of the first hollow tube, and having an opening in the cap sufficient to receive a first end of the second hollow tube; wherein a first end of the second hollow tube is axially inserted through the opening in the cap thereby axially connecting the second hollow tube to the first hollow tube; and a plurality of openings on a second end the first hollow tube for allowing fluid to be released to an exterior side of the first hollow tube. In one embodiment, a distribution tube may be fed directly into the water delivery system through the top end or through an opening in the top portion. In another embodiment, the diameter of the second hollow tube is sufficiently large to receive a drip emitter through a second end of the second hollow tube, thereby allowing fluid to be dripped into the first hollow tube through the second hollow tube.

### BACKGROUND

1. Field of the Invention

The present invention relates generally to plant irrigation and water conservation systems. More particularly, the present invention relates to system for irrigation systems for subterranean delivery of water to plant roots for residential and commercial landscapes.

2. Background of the Invention

Drip irrigation systems are well known in the art. Drip irrigation systems are very important in water conservation areas such as the southwestern United States. Such systems are known to conserve water over other watering techniques such as sprinkler systems. However, improved even greater water conservation is desirable.

FIG. 1 shows a typical drip irrigation system. Simple drip irrigation systems typically comprise water source 10, mainline tubing 12, a plurality of drip emitters 14, and a plurality of distribution tubing 16. Mainline tubing 12 is usually made from poly(vinyl chloride) (PVC) and may vary in diameter. As shown in FIG. 1, Mainline tubing 12 is the connected to water source 10 and is the primary artery of the drip irrigation system. Drip emitters 14 may be directly connected to mainline tubing 12 or may be connected to distal end 18 of distribution tubing 16. Distribution tubing 16 is connected to mainline tubing 12 at one end and allows the water to be delivered to more distant locations. As shown in FIG. 1, distribution tubing 16 may be connected directly to mainline tubing 12 and include a drip emitter connected at distal end 18. Alternatively, distribution tubing 16 may be connected to mainline tubing 12 via drip emitter 14 to regulate the flow of water through distal end 18.

In typical drip irrigation systems, mainline tubing 12 and distribution tubing 16 are buried below ground level 20, as shown in FIG. 2, to prevent inadvertent disruption of the system or for aesthetic reasons. In some known drip irrigation system, emitter 14 and distribution tubing 16 may be buried as well. However, in known drip irrigation systems, it is desirable to keep distal end 18 of distribution tubing 16, and drip emitter 14, above ground level 20 to keep them clean and free of blockages to allow even flow of water to the plant. Further, in known drip irrigation systems, easily locating the emitter and the distribution tubing for repair and maintenance is often desirable. Accordingly, the distal end of distribution tubing 16 and the attached emitter 14 are usually placed above ground near the plant stem or unburied as shown in FIG. 2.

A problem with known drip irrigation systems is that they do not deliver water to the roots of the plants. As noted above, the emitters are typically placed above ground for a variety of reasons. However, as is known in the field, delivery of water closer to a plant's root system is more efficient than systems providing water above the surface. A variety of watering systems have emerged in answer to this problem, but none of these systems are designed to work with the conventional drip irrigation systems described herein. For example, U.S. Pat. No. 6,453,607 to Dewey discloses root level watering and feeding device comprising a “hollow annular liquid dispersion member that circumscribes a center opening of sufficient size to completely encircle a buried root system of a plant and an elongate hollow tubular fill tube connected with the dispersion member which has an upper portion extending upwardly therefrom terminating in an open top end.” To use the device, a cap on the end of the fill tube is removed and liquid (water or plant food) is poured into the tube for delivery to the root. Similar stand alone plant watering devices are disclosed in U.S. Pat. No. 4,745,706 to Muza and Muza; U.S. Pat. No. 5,918,412 to Shen; U.S. Pat. No. 6,138,408 to Paternoster and Jensen.

U.S. Pat. No. 4,153,380 to Hartman discloses a soil penetration emitter for drip irrigation systems comprising an improved emitter specifically designed to be partially buried. The emitter disclosed in Hartman has an “elongated body with a tapered portion at its lower end to facilitate easy insertion into the soil . . . Outlet openings for the emitter are located near or within the tapered portion of the body so that emission is accomplished below ground level.” While the emitter of Hartman may be used with convention drip irrigation systems, the existing emitters must be completely replaced. Accordingly, it requires the purchase and installation of costly additional hardware.

A need therefore exists for an improved system for use with convention drip irrigation systems that is capable of delivering water closer to a plants root system.

A need further exists for a subterranean watering system and method for use with a landscaped area that delivers water at a faster rate but requires less time, thereby conserving overall water usage.

### SUMMARY OF THE INVENTION

The present invention comprises a subterranean watering system and method for use with convention drip irrigation systems or other irrigation systems for watering landscaped areas. The invention allows efficient watering of plant roots and conserves water over convention irrigation systems. An embodiment of the invention is partially buried in the ground near the roots of the plant to be watered. Distribution tubing or a drip emitter from a conventional irrigation system may be inserted into the device without becoming overly clogged. In one embodiment, the present invention allows for distribution tubing from a conventional irrigation system to be used without any drip emitters or valves to regulate the flow of water from the water source. The present invention allows the water to flow directly to the plant roots without overflowing or flooding of the area. Watering a landscaped area according to the present invention conserves water by creating an environment for maximum absorption of the water by the plant roots without wasting water. Accordingly, the invention allows fast but efficient watering of the plant.

In one embodiment, the invention comprises a first hollow tube; a second hollow tube; a cap disposed on a first end of the first hollow tube, and having an opening in the cap sufficient to receive a first end of the second hollow tube; wherein a first end of the second hollow tube is axially inserted through the opening in the cap thereby axially connecting the second hollow tube to the first hollow tube; and a plurality of openings on a second end the first hollow tube for allowing fluid to be released to an exterior side of the first hollow tube. In one embodiment, the second hollow tube has an opening though the wall such that a distribution tube may be inserted into the tube to water the roots of the plant to be watered. In another embodiment, the diameter of the second hollow tube is sufficiently large to receive a drip emitter through a second end of the second hollow tube, thereby allowing fluid to be dripped into the first hollow tube through the second hollow tube.

Another embodiment the present invention comprises a bell-shaped tubular structure having a top end and a bottom end, wherein the top end has a smaller diameter than the bottom end, and wherein the bottom end has a plurality of openings along a portion of the circumference of the bell-shaped tubular structure for allowing fluid to be released to an exterior side of the bell-shaped structure. In one embodiment, the top end has a hole or other opening to allow a distribution tube from an irrigation system to be inserted into the interior of the apparatus, thereby keeping the distribution tubing free of blockages and allowing rapid watering of the plants. In another embodiment, the diameter of the top end is sufficiently large to receive a drip emitter. The length between the top end and the bottom end of the bell-shaped tubular structure should be sufficiently long allow the bottom end to be buried near a base of a plant thereby delivering the fluid through the plurality of openings to a level at least one inch below the soil.

### BRIEF DESCRIPTION OF THE DRAWINGS

FIG. 1 shows the components of conventional drip irrigation system.

FIG. 2 shows a conventional drip irrigation systems installed into a typical landscaped area.

FIG. 3 shows a subterranean watering system according to the present invention.

FIG. 4 shows cross-sectional view of a subterranean watering system including a distribution tube according to the present invention.

FIG. 5 shows cross-sectional view of a subterranean watering system including a drip emitter according to the present invention.

FIG. 6 shows cross-sectional view of another embodiment of a subterranean watering system according to the present invention.

FIG. 7 shows a subterranean watering system according to the present invention, installed into a landscaped area.

FIG. 8 shows another embodiment of a system subterranean watering according to the present invention.

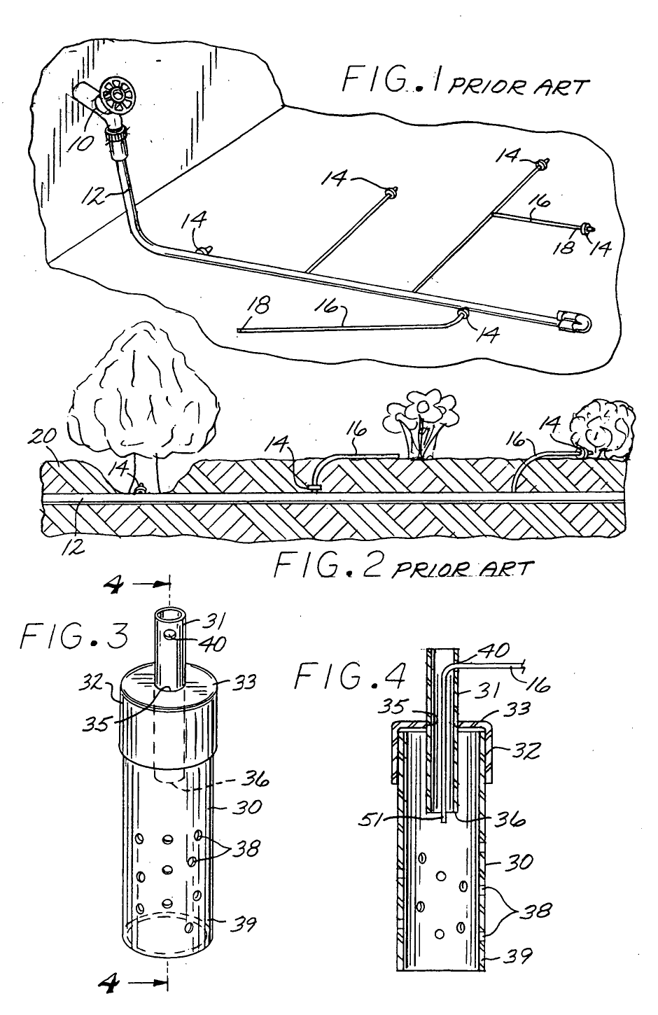

### DETAILED DESCRIPTION OF THE INVENTION

Referring to FIG. 3, a water delivery system for use with irrigation systems according to the present invention comprises: first hollow tube 30; second hollow tube 31; cap 32 disposed on a first end 33 of first hollow tube 30, and having opening 35 sufficient to receive first end 36 of second hollow tube 31. As shown in FIG. 3, first end 36 of second hollow tube 31 is axially inserted through opening 35 thereby axially connecting the second hollow tube to the first hollow tube. Further, a plurality of openings 38 on second end 39 of first hollow tube 30 allow fluid to be released to an exterior side of the first hollow tube.

As shown in FIG. 4 an embodiment of the present invention includes hole 40 in second hollow tube 31 used to insert distal end 18 of distribution tubing 16 into the subterranean watering system. In this embodiment, no drip emitter is needed on the distal end 18 of distribution tubing 16. Further, no valve or drip emitter is needed for the connection between distribution tubing 16 and mailing tubing 12 (not shown in FIG. 4). That is, in this embodiment, the flow of water need not be regulated as it flows out of distribution tubing 16. As described in more detail below, the present invention allows for a much faster watering rate while still reducing the overall amount of water needed to properly feed a plant. In addition to the highly effective conservation of water, the present invention reduces the points of failure in an irrigation system for landscaped areas by eliminating the need for mechanical vales or drip emitters.

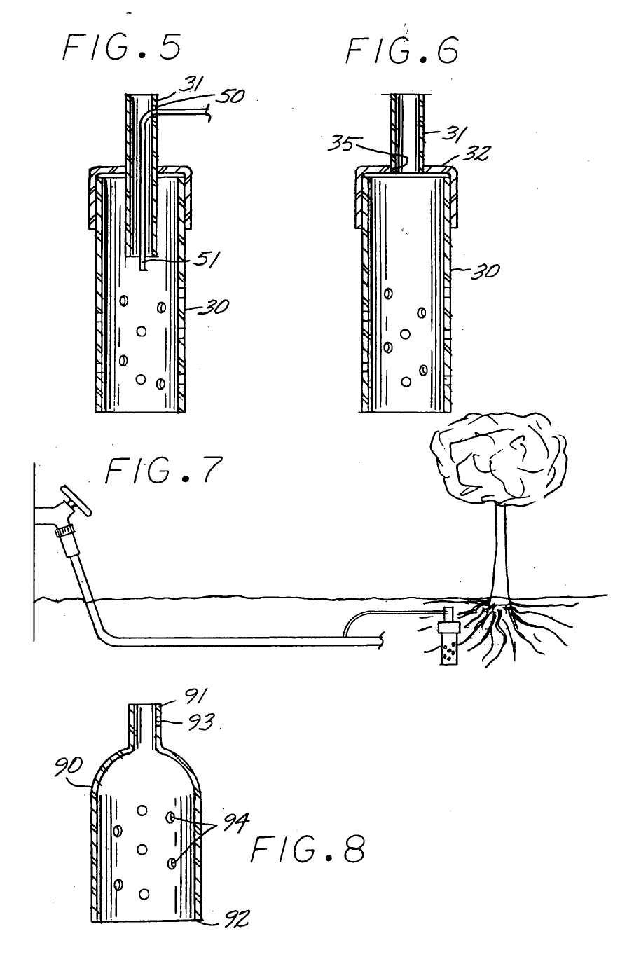

FIG. 5 shows an alternative way to use an embodiment of the present invention with a conventional drip irrigation system. As shown in FIG. 5, the diameter of second hollow tube 31 in this embodiment should be sufficiently large to receive drip emitter 14 through second end 52 of second hollow tube 31, thereby allowing fluid to be dripped into first hollow tube 30 through second hollow tube 31. A subterranean watering system according to the present invention as shown in FIG. 5, thereby protects the drip emitters and makes it easier locate the drip emitters even though they are buried below the ground.

In one embodiment, first end 36 of second hollow tube 31 may extend into the cavity of first hollow tube 30 as shown in FIG. 3. In this embodiment, the additional length of tubing may be advantageous to prevent clogging of the emitter by soil particles. In another embodiment, first end 36 of second hollow tube 31 need not extend into the cavity of first hollow tube 30 as shown in FIG. 6.

As shown in FIG. 7, the improved water delivery system according to the present invention is partially buried in the ground near the root system of a plant to be watered. The distribution tubing or drip emitter inserted into to the top of the device allows water to drip into the soil near the roots.

A water delivery system according to the present invention includes a plurality of openings 38 on the second end 39 of the first hollow tube 30 as described above. Such openings may comprise holes, such as shown in FIG. 3, or may include slits in the hollow tube, or other shapes allowing water to seep out of the tube. The holes or slits comprising the plurality of openings need not be uniform in size and need not be uniformly situated around the bottom end of the tube. In one embodiment of the present invention, the plurality of openings are sufficiently located around the circumference of the tube such that water, or other fluids may be released at a plurality of elevations relative to the second end of the first hollow tube, as shown in FIG. 3. As further shown in FIG. 3, the plurality of openings in an embodiment of the invention are situated at various intervals around the circumference of the tube to allow greater range for the dispersion of the water or fluid into the soil around the water delivery system. In one embodiment, the plurality of openings are separated by 90 degrees around the circumference to allow dispersion at least to each quadrant of soil around the water delivery system.

As shown in FIG. 7, an embodiment of the present invention may also include water source 10, mainline tubing 12, and a plurality of distribution tubing 16. In this embodiment, a portion the water delivery system is inserted into the soil near a portion of the plant's root system and the drip emitter, including a portion of the distribution tube is inserted into the second end of the second hollow tube.

Another embodiment of the present invention is shown in FIG. 8. In this embodiment, the improved water delivery system comprising a bell-shaped tubular structure 80 having a stem 81 and a bottom end 82. Stem 81 preferably has a smaller diameter than bottom end 82. Further, bottom end 82 has a plurality of openings 83 along a portion of the circumference of bell-shaped tubular structure 80 for allowing water or other fluids to be released to an exterior side of bell-shaped structure 80. The diameter of stem 81 may be sufficiently large to receive a drip emitter or alternatively a hole 84 may be in stem 81 to receive distribution tubing. The length between the top end of the stem and the bottom end of the bell-shaped tubular structure should be sufficiently long to allow the bottom end to be buried near a base of a plant thereby delivering the water or other fluid through the plurality of openings to a level at least one inch below the soil.

As described herein, in one embodiment, the plurality of openings 83 on the bottom end 82 of the bell-shaped structure 80 sufficiently circumscribe the structure such that fluid may be released at least at 80 degree intervals around the structure.

As described herein, in one embodiment, the plurality of openings 83 on the bottom end 82 of the bell-shaped structure 80 are sufficiently located such that fluid may be released at a plurality of elevations relative to the bottom end of the structure.

A water delivery system according to the present invention may be made from poly(vinyl chloride) material or any other suitable manufacturing material, including for example, plastic, stainless steel, or other non-corrosive material as known in the art. As further known in the art, a water delivery system according to the present invention may comprise a single-bodied structure made via an injection molding process or other suitable manufacturing process.

Watering a landscaped area according to the present invention takes much less time and much less water when compared to a conventional drip system. Table 1 shows illustrates to the results. The data in Table 1 was generating based on watering the same landscape area using thirty-six (36) units in all. In both instances, the watering time and watering rates were adjusted to achieve the same overall health of the plants being watered. As shown in the table, using a conventional drip irrigation watering system, to achieve the desired plant health results, the convention drip irrigation system had to be adjusted to water at a slower rate but for a much longer period of time. Using the convention system, 49.2 gallons of water per day were required to effectively water the landscaped area. In contrast, using a subterranean watering system according to the present invention, the watering time can be significantly shortened while output rate for the water is increased. As a result, when using a subterranean watering system according to the present invention to water the same landscaped area the overall water output necessary to achieve the same health of the plants is only 14.6 gallons per day. As shown in Table 1, the present invention is capable of yielding at least a 70% reduction in the amount of water necessary to water the landscaped area.

Table 2 further illustrates the tremendous advantages over the conventional watering systems. In this example, the watering time was reduced to only three (3) minutes per day on a very hot day in the middle of summer in an area of Arizona, United States, having minimal rainfall and average temperatures in the 100 degrees Fahrenheit range. The plants still thrived on the minimal water supplied via an embodiment of the present invention. In this experiment, the present invention resulted in almost 80% conservation of water over conventional watering systems.

As would be apparent to one of ordinary skill in the art the watering times and rates will vary according to various factors such as the type of plants being watered, the climate where the drip irrigation system is installed and the season variations. Accordingly, the results for individual applications of the present invention will vary. However, the results shown in Tables 1 and 2, effectively illustrate that the present invention is a dramatic improvement over conventional drip irrigation systems wherever and when ever used.

TABLE 1

| Watering Using Conventional Drip | | Watering Using Subterranean | |
|---|---|---|---|
| Irrigation System | | Watering System | |
| Run time minutes | 17.5 | Run time minutes | 4 |
| Ounces per head | 10 | Ounces per head | 13 |
| Heads | 36 | Heads | 36 |
| Gallons per run time | 49.2 | Gallons per run time | 14.6 |
| Days | 31 | Days | 31 |
| Gallons used per month | 1,526 | Gallons used per month | 453 |

TABLE 2

| Watering Using Conventional Drip | | Watering Using Subterranean | |
|---|---|---|---|
| Irrigation System | | Watering System | |
| Run time minutes | 17.5 | Run time minutes | 3 |
| Ounces per head | 10 | Ounces per head | 13 |
| Heads | 36 | Heads | 36 |
| Gallons per run time | 49.2 | Gallons per run time | 11 |
| Days | 31 | Days | 31 |
| Gallons used per month | 1,526 | Gallons used per month | 340 |

The present invention also comprises a method for subterranean watering of landscaped areas using a subterranean watering apparatus as described herein. The method includes the steps of burying a subterranean watering apparatus near the base of the plant to be watered. As described herein, the top end of the subterranean watering apparatus should be exposed above ground level to allow easy insertion of the water distribution tube. The next step in the method is to insert a water distribution tube into the top end of the subterranean watering apparatus. The final step in the method is to allow water to flow through the water distribution tube to water the plant. Naturally, in the method described herein, the water distribution tube may include a drip emitter attached to the distal end. However, as described herein, no drip emitter is required to produce the greatly improved water conservation results described herein.

Although embodiments of the present invention described herein include several components, as known in the art, an embodiment of the present invention may be completely formed out of a singular piece through injection molding or other manufacturing techniques. The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A subterranean watering system for use with irrigation systems, said system comprising:
(a) a first hollow tube;
(b) a second hollow tube;
(c) a cap disposed on a first end of the first hollow tube, and having an opening in the cap sufficient to receive a first end of the second hollow tube;
(d) wherein a first end of the second hollow tube is axially inserted through the opening in the cap thereby axially connecting the second hollow tube to the first hollow tube; and
(e) a plurality of openings on a second end of the first hollow tube for allowing fluid to be released to an exterior side of the first hollow tube.

2. The subterranean watering system of claim 1, wherein a diameter of the second hollow tube is sufficiently large to receive a distribution tubing through a second end of the second hollow tube, thereby allowing fluid to flow through the distribution tubing into the first hollow tube through the second hollow tube.

3. The subterranean watering system of claim 1, further comprising an opening near a top end of the second hollow tube to receive a distribution tubing through the opening, thereby allowing fluid to flow through the distribution tubing into the first hollow tube through the second hollow tube.

4. The subterranean watering system of claim 1, wherein a diameter of the second hollow tube is sufficiently large to receive a drip emitter through a second end of the second hollow tube, thereby allowing fluid to be dripped into the first hollow tube through the second hollow tube.

5. The subterranean watering system of claim 1, wherein a portion of the first end of the second hollow tube protrudes into a portion of the first hollow tube.

6. The subterranean watering system of claim 1, wherein the plurality of openings on the second end of the first hollow tube sufficiently circumscribe the tube such that fluid may be released at least at 90 degree intervals around the tube.

7. The subterranean watering system of claim 1, wherein the plurality of openings on the second end of the first hollow tube are sufficiently located such that fluid may be released at a plurality of elevations relative to the second end of the first hollow tube.

8. The subterranean watering system of claim 1, wherein the first hollow tube, the second hollow, and the cover are made of poly(vinyl chloride) material.

9. The subterranean watering system of claim 1, further comprising:
(a) a water source;
(b) a mainline tube, connected at a first end to the water source; and
(c) a distribution tube, connected a first end to the mainline tube;
wherein, the a portion of the first hollow tube is inserted into a soil near a portion of a plant's root system and a portion of the distribution tube is inserted into the second end of the second hollow tube.

10. The subterranean watering system of claim 9, wherein the distribution tube is connected to the mainline tube via a drip emitter to restrict the flow of water from the water source.

11. The subterranean watering system of claim 9, wherein the distribution tube is connected to the mainline tube via valve to restrict the flow of water from the water source.

12. The subterranean watering system of claim 9, further comprising a drip emitter attached to distribution tube.

13. The subterranean watering system of claim 11, wherein the drip emitter and distribution tube are inserted such that the drip emitter does not extend past the first end of the second tube.

14. A subterranean watering system for use with irrigation systems, comprising a bell-shaped tubular structure having a top end and a bottom end, wherein the top end has a smaller diameter than the bottom end, and wherein the bottom end has a plurality of openings along a portion of the circumference of the bell-shaped tubular structure for allowing fluid to be released to an exterior side of the bell-shaped structure, wherein a length between the top end and the bottom end of the bell-shaped tubular structure is sufficiently long to allow the bottom end to be buried near a base of a plant thereby delivering the fluid through the plurality of openings to a level at least one inch below the soil.

15. The subterranean watering system of claim 14, further including an opening in the top end to receive a distribution tube into an interior of the bell-shaped tubular structure.

16. The subterranean watering system of claim 14, wherein a diameter of the top end is sufficiently large to receive a drip emitter into an interior of the bell-shaped tubular structure.

17. The subterranean watering system of claim 14, wherein the plurality of openings on the bottom end of the bell-shaped structure sufficiently circumscribe the structure such that fluid may be released at least at 90 degree intervals around the structure.

18. The subterranean watering system of claim 14, wherein the plurality of openings on the bottom end of the bell-shaped structure are sufficiently located such that fluid may be released at a plurality of elevations relative to the bottom end of the structure.

19. A method for subterranean watering of landscaped areas comprising:
(a) burying a subterranean watering apparatus near a base of a plant to be watered such that a top end of the subterranean watering apparatus is exposed above ground level;
(b) inserting a water distribution tube into the top end of the subterranean watering apparatus;
(c) allowing water to flow through the water distribution tube to water the plant.

20. The method for subterranean watering of landscaped areas of claim 19, wherein the water distribution tube includes a drip emitter attached to a distal end.
